(19) United States
(12) Patent Application Publication
(10) Pub. No.: US 2024/0351814 A1
(43) Pub. Date: Oct. 24, 2024

(54) PAPER CONVEYING DEVICE

(71) Applicant: Toshiba Tec Kabushiki Kaisha, Tokyo (JP)

(72) Inventor: Susumu NOMURA, Yokohama Kanagawa (JP)

(73) Assignee: Toshiba Tec Kabushiki Kaisha, Tokyo (JP)

(21) Appl. No.: 18/414,859

(22) Filed: Jan. 17, 2024

(30) Foreign Application Priority Data
Apr. 19, 2023 (JP) 2023-068461

(51) Int. Cl. B65H 16/02

(52) U.S. Cl. CPC B65H 16/02; B41J 3/4075; B41J 15/02; B41J 15/042; B65H 2301/4136; B65H 2403/411; B65H 2405/451; B65H 2553/414

(57) ABSTRACT

A paper conveying device includes a support shaft configured to pivotally support a roll of paper having a center measured in a width direction, a guide movable in the width direction of the roll based on a size of the roll and configured to position the center of the roll in a reference position, and a sensor coupled to the guide and configured to detect that the roll contains less than a threshold amount of paper based on a diameter of the roll.

### CROSS-REFERENCE TO RELATED APPLICATION

This application is based upon and claims the benefit of priority from Japanese Patent Application No. 2023-068461, filed on Apr. 19, 2023, the entire contents of which are incorporated herein by reference.

### FIELD

Embodiments described herein relate generally to a paper conveying device.

### BACKGROUND

A paper conveying device that conveys paper such as labels and receipts is equipped with a roll of rolled paper, and the paper is pulled out from the outermost circumference of the roll paper for use. For example, if the paper conveying device is a printer, this roll paper is used to print information on the pulled paper using a print head.

Roll paper comes in various sizes having different paper widths depending on the purpose, and there are two types of paper conveying devices: one type in which the roll paper is pressed against one side with one side of the roll paper as a reference, and the other type in which the center of the roll paper is mounted at a fixed position based on the widthwise center of the roll paper.

On the other hand, the diameter of the roll paper loaded on the paper conveying device gradually decreases as it is used. A near-end sensor mounted on the paper conveying device detects a decrease in the diameter of the mounted roll paper as it is used, and detects whether the roll paper is at the near-end.

This near-end sensor is often a reflective optical sensor and is fixed at a predetermined position on the paper conveying device. Therefore, in a paper conveying device on which the center of the roll paper is mounted as a reference, the distance between the near-end sensor and one side of the loaded roll paper differs depending on the size of the loaded roll paper, and the distance between the near-end sensor and the roll paper becomes greater if a narrow roll paper is loaded than if a wide roll paper is loaded. Therefore, if a narrow roll paper is loaded, the detection accuracy of the near-end sensor may deteriorate.

### DESCRIPTION OF THE DRAWINGS

FIG. 1 is an external perspective view of a printer according to an embodiment;

FIG. 2 is a schematic perspective view illustrating the internal configuration of the printer;

FIG. 3 is a diagram illustrating the configuration of a support shaft and a rack and pinion;

FIG. 4 is an explanatory diagram illustrating a mechanism for setting roll paper;

FIG. 5 is a schematic perspective diagram illustrating the internal configuration of the printer with roll paper set;

FIG. 6 is an explanatory diagram of a state in which wide roll paper is set;

FIG. 7 is an explanatory diagram of a state in which narrow roll paper is set;

FIG. 8 is a diagram illustrating the mounting structure of the sensor harness; and

FIG. 9 is a diagram illustrating the state of movement of the sensor harness as the rear guide moves.

### DETAILED DESCRIPTION

Embodiments provide a paper conveying device of a type that is mounted on the center of the roll paper in the width direction as a reference, in which the detection accuracy of a near-end sensor can be maintained even if roll papers of different widths are loaded in the paper conveying device.

In general, according to one embodiment, a paper conveying device includes a support shaft that pivotally supports a plurality of types of roll paper having different widths, a guide movable in the width direction of the roll paper according to the type of roll paper pivotally supported on the support shaft, which positions the roll paper pivotally supported by the support shaft in the center of the width direction of the roll paper in a reference position; and a sensor that is attached to the guide and detects a near end due to a change in the diameter of the roll paper.

Embodiments will be described below. Note that in the embodiment, a printer will be described as an example of a paper conveying device. Further, in the embodiment, a long label paper in which a plurality of heat-sensitive labels are attached to a long backing paper will be described as an example of roll paper (e.g., paper on a roll, a roll of paper, etc.). That is, the printer of the embodiment conveys a plurality of labels attached to a long backing paper. In addition, the present disclosure is not limited by embodiments described below.

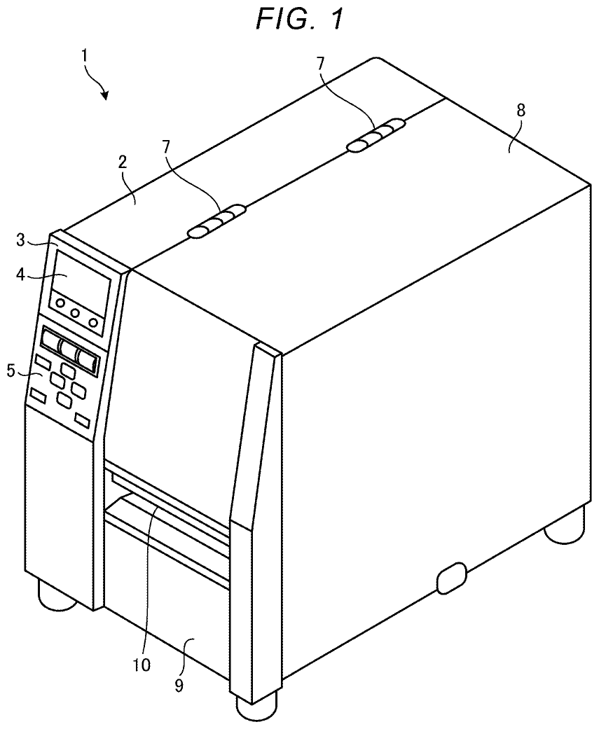

FIG. 1 is an external perspective view of a printer 1 according to an embodiment. The printer 1 according to the embodiment is a label printer that prints information on a label and dispenses the label. As illustrated in FIG. 1, the printer 1 includes a left case 2 and a case 8 connected to the right side of the case 2 by a hinge 7 (e.g., to form a housing). A front panel 3 formed on the front surface of the case 2 includes a display unit 4 (e.g., an output portion of a user interface) and an operation unit 5 (e.g., an input portion of the user interface. Although the display unit 4 is composed of a liquid crystal display with a backlight, other types of display devices may be used.

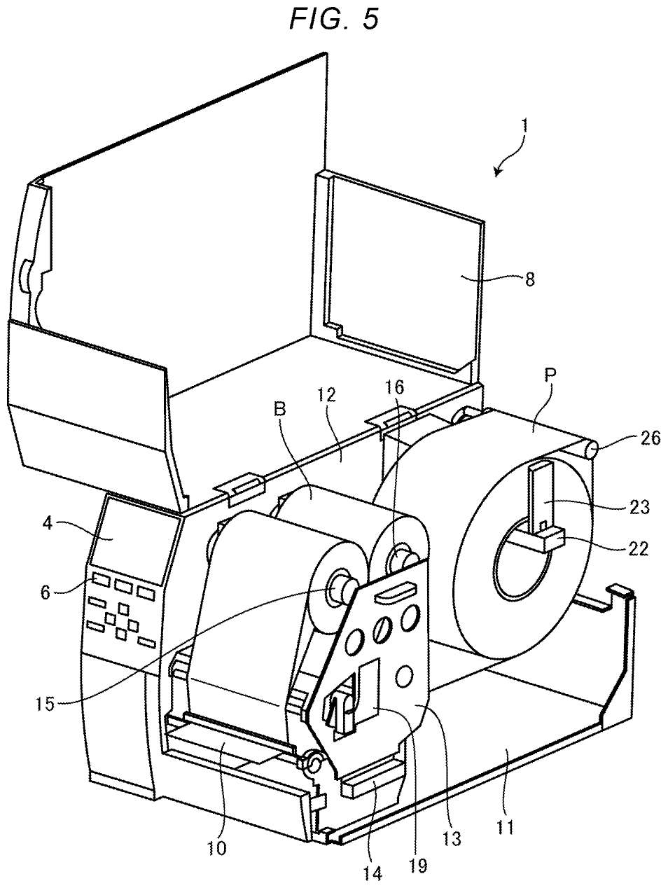

The case 8 on the right side has a structure in which the interior of the housing (that is, the cases 2 and 8) can be largely opened from the side by rotating upward about the hinge 7. As will be described later with reference to FIG. 5, the printer 1 has a roll paper P wound in a roll shape with a plurality of labels attached to a backing paper inside the housing, and a printing unit (e.g., a printer) for printing on a label (e.g., paper) pulled out from the roll paper P. A front panel 9 provided on the front side of the case 8 is provided with a label dispensing port 10 or aperture. The printer 1 dispenses the printed label from the label dispensing port 10.

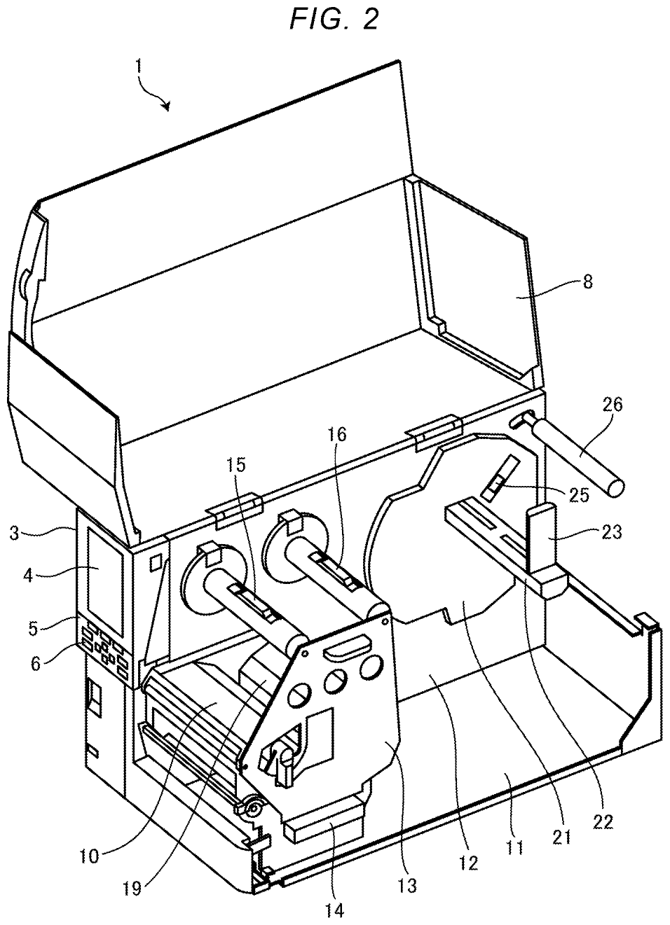

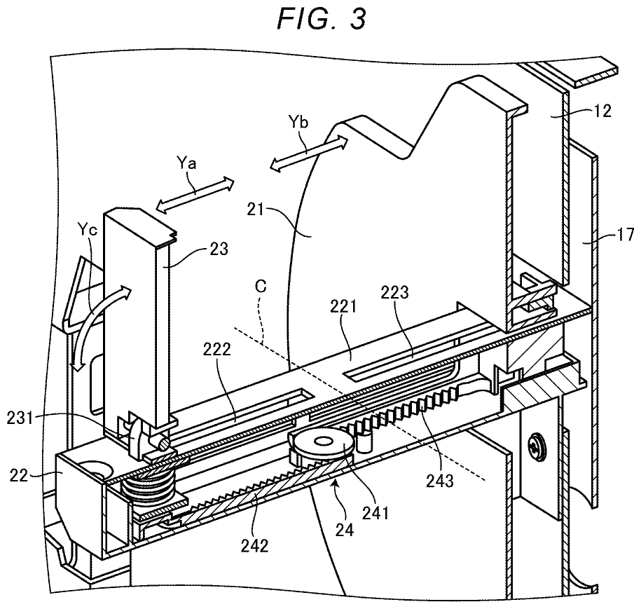

FIG. 2 is a diagram illustrating a state in which the case 8 is rotated upward about the hinge 7 and the inside of the printer 1 is opened (e.g., an open configuration or maintenance configuration). As illustrated in FIG. 2, the printer 1 has a bottom surface 11. The printer 1 also has a planar frame 12 that stands upward from the bottom surface 11 at a substantially right angle. The frame 12 is a plate-like member (e.g., a partition or partition unit) that stands up near the hinge 7 and separates the mechanism unit (e.g., a guide assembly) and the control unit (e.g., a motor portion or control portion). The mechanism unit (on the front side of the frame 12 in FIG. 2) includes a driving shaft 15, a driven shaft 16, a support shaft 22, a rear guide 21, and the like. In the control unit (on the back side of the frame 12 in FIG. 2), a circuit board 17 (e.g., a controller or processing circuity, see FIG. 3) on which a control circuit such as a microprocessor for controlling the printer 1 is integrated, and a power supply unit (e.g., a power supply) are placed.

The driven shaft 16 is a shaft to which an ink ribbon B (see FIG. 5) coated with thermal ink is pivotally supported. The driving shaft 15 is rotated by a drive motor (e.g., an electric motor) provided in the control unit. The driving shaft 15 is a shaft that rotates to pull out and wind up the ink ribbon B attached to the driven shaft 16. The driving shaft 15 and the driven shaft 16 are each attached to the frame 12 in a cantilevered manner. That is, the ink ribbon B is inserted and attached to the driven shaft 16 from the side opposite to the frame 12. In the ink ribbon B, the plate 13 rotatably attached to a rotating shaft 14 is folded down, inserted into the driven shaft 16, and the plate 13 is returned to its original position. By attaching the ink ribbon B to the driven shaft 16 in this manner, the ink ribbon B is attached so as not to come off the driven shaft 16.

Further, the support shaft 22 is attached to the rear part of the printer 1. The support shaft 22 is a shaft that rotatably supports the roll paper P to which a plurality of labels are attached. The support shaft 22 is attached to the frame 12 in a cantilevered manner. That is, the roll paper P is inserted and loaded to the support shaft 22 from the side opposite to the frame 12. The roll paper P loaded to the support shaft 22 is rotatably supported by the support shaft 22.

Furthermore, the rear guide 21 and a front guide 23 are attached to the support shaft 22. The rear guide 21 is provided on the side of the support shaft 22 that is closer to the frame 12. The front guide 23 is provided on the side of the support shaft 22 that is away from the frame 12. The rear guide 21 and the front guide 23 are movable on the support shaft 22 in the directions of moving away from and toward each other, and position the center portion of the loaded roll paper P in the width direction by a rack and pinion 24, which will be described later with reference to FIG. 3. Regardless of whether the roll paper P is wide or narrow, the center portion of the roll paper P in the width direction is positioned at the same position. The position where this center portion is positioned is a reference position C (see FIG. 3), and the center portion of the roll paper P in the width direction is always positioned at the reference position C by the rack and pinion 24.

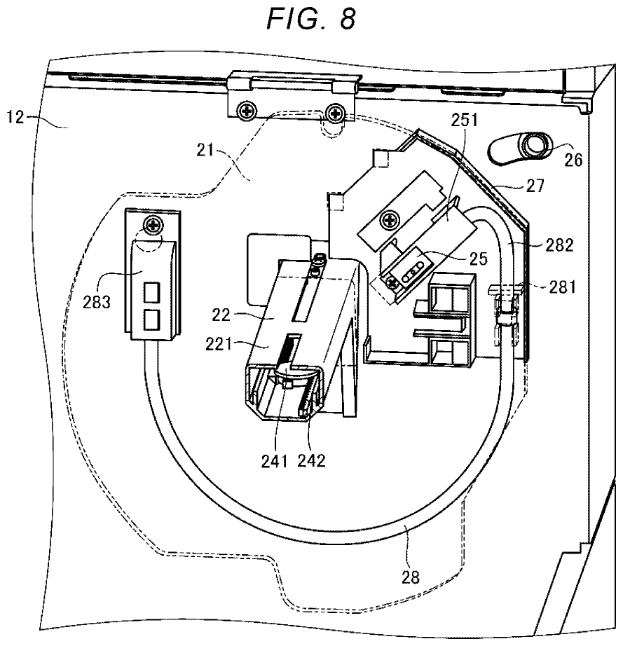

Further, a sensor 25 is attached to the rear guide 21. The sensor 25 is a reflective optical sensor that emits, for example, infrared light and receives light reflected from the side surface of the roll paper P loaded on the support shaft 22 on the side of the rear guide 21. The sensor 25 can be attached at a position at which the sensor receives the light reflected from the side surface of the roll paper P if the diameter of the roll paper P is large, and does not reflect the received light on the side surface of the roll paper P if the diameter of the roll paper P decreases and becomes a near-end state. In other words, if the diameter of the roll paper P decreases due to printing of a label and the amount of reflected light on the side surface of the roll paper P becomes a predetermined amount or less, the sensor 25 detects the near end and outputs the detected output (e.g., a voltage) to the control unit (e.g., to the circuit board 17) through a sensor harness 28 (see FIG. 8). The microprocessor determines the near end of the roll paper P based on the output received from the sensor 25.

This sensor 25 has high near-end detection accuracy because the amount and intensity of reflected light are high if the distance from the roll paper P is short, but the amount and intensity of reflected light decrease as the distance from the roll paper P increases. As a result, near-end detection accuracy may decrease.

Further, a damper 26 is attached to the frame 12. The damper 26 has an elongated, substantially cylindrical shape, and has a structure that bends (or moves elastically) in one direction if force is applied. The damper 26 is bridged by the paper that is just pulled out from the roll paper P, and the damper 26 flexes and reduces the impact that is applied to the roll paper P due to the paper tension that occurs if the paper starts to be conveyed for printing.

Next, the structure around the support shaft 22 will be described. FIG. 3 is a diagram illustrating the configuration of the support shaft 22 and the rack and pinion 24. The support shaft 22 is attached to the frame 12 at a substantially right angle. Since the frame 12 is provided substantially perpendicular to the bottom surface 11, the support shaft 22 is supported by the frame 12 so as to be substantially parallel to the bottom surface 11.

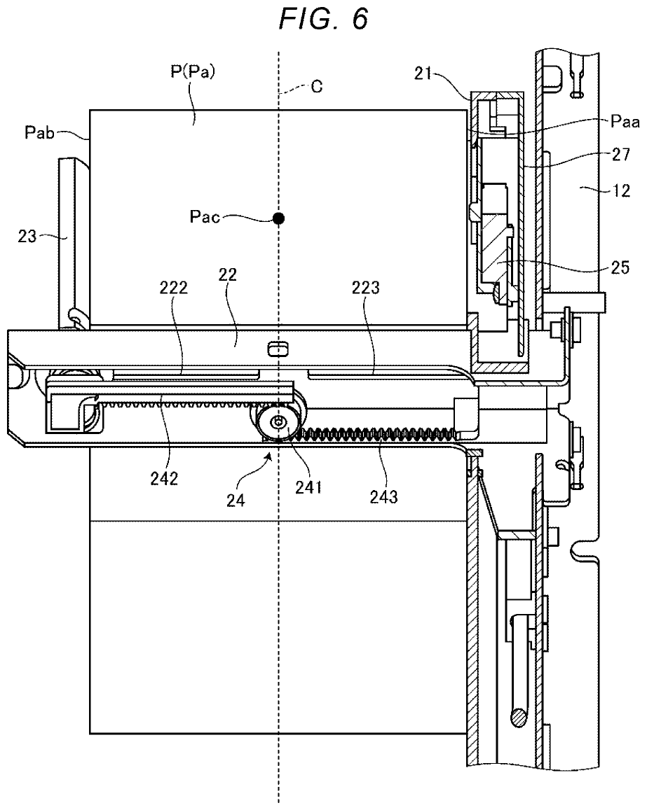

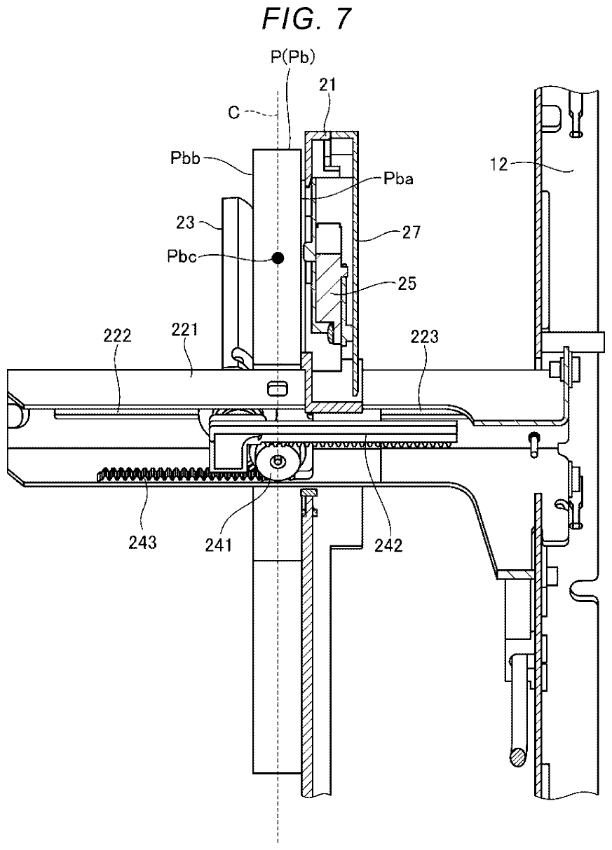

The support shaft 22 has a hollow elongated box structure (e.g., defines a hollow internal volume), and has a planar flat portion 221 at the top. The rack and pinion 24 is built inside the support shaft 22. The rack and pinion 24 positions the roll paper P loaded to the support shaft 22 with respect to the center. The center reference means that the central portion of the roll paper P in the width direction (Pac in FIG. 6 and Pbc in FIG. 7) if a plurality of types of roll paper P with different widths are loaded on the support shaft 22 is always positioned at the reference position C.

If the roll paper P is positioned based on the center reference, no matter which roll paper P has different widths, the load on the roll paper P that occurs when conveying the roll paper P is applied evenly on the left and right sides, and thus, it becomes possible to stably convey the roll paper P having different widths.

The rack and pinion 24 (e.g., a rack and pinion assembly, a timing assembly, etc.) includes a rotating shaft 241, which is a cylindrical rotatable gear (e.g., a pinion gear) located in the center portion, a linear movable portion 242 (e.g., a first rack gear) having gear teeth meshed (hereinafter referred to as “engaged”) with the rotating shaft 241, and a linear movable portion 243 (e.g., a second rack gear) having gear teeth engaged with the rotating shaft 241 on the opposite side of the movable portion 242. The movable portion 242 moves in the width direction of the roll paper P if the rotating shaft 241 rotates. Conversely, if the movable portion 242 is moved in the width direction of the roll paper P, the rotating shaft 241 rotates. Moreover, the movable portion 243 moves in the width direction of the roll paper P if the rotating shaft 241 rotates. Conversely, if the movable portion 243 is moved in the width direction of the roll paper P, the rotating shaft 241 rotates. Since the movable portion 242 and the movable portion 243 are located on opposite sides via the rotating shaft 241, they move in opposite directions to each other if the rotating shaft 241 rotates.

The front guide 23 is attached to the movable portion 242. Specifically, the front guide 23 is attached to the movable portion 242 so as to protrude upward from the flat portion 221 (e.g., a flat surface). That is, the front guide 23 attached to the movable portion 242 is erected upward from the support shaft 22. The front guide 23 attached to the movable portion 242 is rotatable about a rotation fulcrum 231 between an erected position with respect to the flat portion 221 and a collapsed position (in the direction of arrow Yc). A distal end of the front guide 23 is closer to the flat portion 221 in the collapsed position than in the erected position. When loading the roll paper P on the support shaft 22, the front guide 23 is brought down to the collapsed position, the roll paper P is fitted onto the support shaft 22, and then the front guide 23 is erected in the erected position, thereby the paper P will not come off the support shaft 22.

Furthermore, the rear guide 21 is attached to the movable portion 243. The rear guide 21 is a substantially circular plate, and the support shaft 22 passes through the center portion thereof. The rear guide 21 is attached to the movable portion 243 so that its circular surface is perpendicular to the support shaft 22.

Further, the flat portion 221 is formed with a long hole 222 (e.g., a first slot) penetrating the flat portion 221 and a long hole 223 (e.g., a second slot) penetrating the flat portion 221. The long hole 222 and the long hole 223 are slit-like holes formed so that their longitudinal directions are opposite to each other in the width direction of the roll paper P from the reference position C.

The front guide 23 is attached to the movable portion 242 through the long hole 222, and if the movable portion 242 moves, the front guide 23 can move in the longitudinal direction of the long hole 222. Further, the rear guide 21 is attached to the movable portion 243 via the long hole 223, and if the movable portion 243 moves, the rear guide 21 can move in the longitudinal direction of the long hole 223.

Here, in FIG. 3, if the front guide 23 is moved in the width direction of the roll paper P in the direction approaching the reference position C (one direction of the arrow Ya), the rear guide 21 connected by the rack and pinion 24 moves toward the reference position C (in the direction of arrow Yb, opposite to the above-mentioned one direction). Moreover, if the front guide 23 is moved in the width direction of the roll paper P in the direction away from the reference position C (in the opposite direction to the one direction of the arrow Ya), the rear guide 21 connected by the rack and pinion 24 moves in a direction away from the reference position C (in the direction of arrow Yb, the above-mentioned one direction). That is, if the front guide 23 is moved toward the reference position C, the rear guide 21 moves in the direction closer to the front guide 23 (in the direction closer to the reference position C), and if the front guide 23 is moved away from the reference position C, the rear guide 21 moves in the direction away from the front guide 23 (in the direction away from the reference position C). In this case, no matter where the front guide 23 and the rear guide 21 are located, the center portion between the front guide 23 and the rear guide 21 is located at the reference position C.

Furthermore, since the sensor 25 is attached to the rear guide 21, if the rear guide 21 moves in the width direction of the roll paper P, the sensor 25 also moves in the width direction of the roll paper P. That is, if the front guide 23 is moved in the width direction of the roll paper P in a direction approaching the reference position C, the rear guide 21 moves in the direction approaching the reference position C together with the sensor 25. If the front guide 23 is moved in the width direction of the roll paper Pin a direction away from the reference position C, the rear guide 21 moves in the direction away from the reference position C together with the sensor 25.

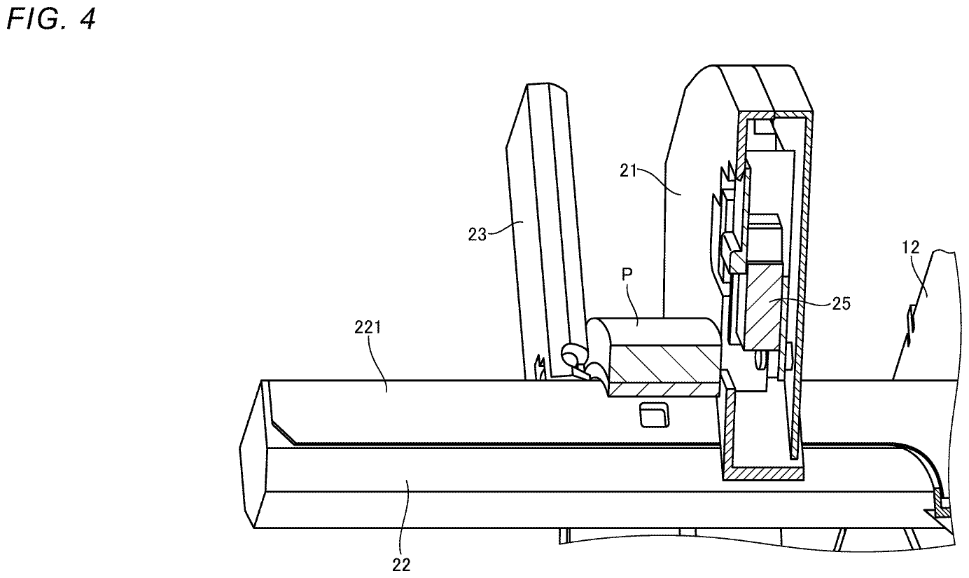

FIG. 4 illustrates a state in which the roll paper P is loaded to the support shaft 22, the front guide 23 and the rear guide 21 are then moved to match the width of the roll paper P, and the roll paper P is loaded (set) to the support shaft 22. In this state, the front guide 23 and the rear guide 21 are in contact with or near contact with the respective side surfaces of the roll paper P. Therefore, although the roll paper P is rotatable with respect to the support shaft 22, the movement of the roll paper P in the width direction is restricted by the front guide 23 and the rear guide 21, and the center portion of the roll paper P in the width direction is at reference position C.

Furthermore, since the distance between the roll paper P and the rear guide 21 is constant even if the width of the loaded roll paper P is different, the distance between the sensor 25 and the roll paper P is always the same distance (constant). Therefore, the near-end detection accuracy of the roll paper P by the sensor 25 does not deteriorate and is maintained at a constant level.

FIG. 5 illustrates a state in which the ink ribbon B and the roll paper P are loaded to the printer 1. The ink ribbon B is pulled out from the mounted driven shaft 16 and set so as to be attached to the driving shaft 15 through between a print head 19 and a platen provided near the label dispensing port 10. Further, the leading edge of the outermost peripheral part of the roll paper P loaded on the support shaft 22 (backing paper with a label) is pulled out toward the damper 26 and bridges over the damper 26 (hereinafter, the pulled out paper is referred to as “paper”). Then, the bridged paper is folded back by the damper 26, passes between the print head 19 and the platen, the print head 19 prints on the label using the ink ribbon B, and the label is dispensed from the label dispensing port 10.

The platen rotates and conveys paper in order to print a label and to dispense a printed label. If the paper is conveyed, tension is generated in the paper, and the tension is transmitted to the roll paper P as an impact. However, the damper 26 located halfway bends in response to the tension, thereby reducing the impact transmitted to the roll paper P.

FIG. 6 illustrates a state in which a wide roll paper P (Pa) is loaded on the support shaft 22. That is, the roll paper P (Pa) is fitted into the support shaft 22 and supported by the rear guide 21 and the front guide 23 sandwiching the roll paper P (Pa). In this state, the rear guide 21 is in contact with the back side surface Paa (one surface) of the roll paper P (Pa). Further, the front guide 23 is in contact with the front surface Pab of the roll paper P (Pa). As illustrated in FIG. 6, since the roll paper P (Pa) is wide, the rear guide 21 and the front guide 23 support the roll paper P (Pa) at positions separated from each other. In this state, the center portion Pac of the roll paper P (Pa) in the width direction is at the reference position C.

The sensor 25 is attached to the rear guide 21 by attaching a base 27 on which the sensor 25 is attached to the rear guide 21.

Here, since the rear guide 21 is in contact with the surface Paa of the roll paper P (Pa), the sensor 25 and the roll paper P (Pa) are kept close to each other at a predetermined distance. In this state, if the roll paper P (Pa) is used, the diameter of the roll paper P (Pa) decreases, and the diameter becomes smaller than a predetermined diameter, and if the reflected amount of the light emitted from the sensor 25 by the surface Paa becomes less than or equal to a predetermined amount, the sensor 25 detects that the roll paper P (Pa) is near-end (output indicating that it is near-end, is close to being depleted, contains less than a threshold amount of paper).

FIG. 7 illustrates a state in which narrow roll paper P (Pb) is loaded on the support shaft 22. That is, the roll paper P (Pb) is fitted into the support shaft 22 and supported by the rear guide 21 and the front guide 23 sandwiching the roll paper P (Pb). In this state, the rear guide 21 is in contact with the back side surface Pba of the roll paper P (Pb). Further, the front guide 23 is in contact with the front surface Pbb of the roll paper P (Pb). As illustrated in FIG. 7, since the roll paper P (Pb) is narrow, the rear guide 21 and the front guide 23 support the roll paper P (Pb) at positions closer to each other than the wide roll paper P (Pa) shown in FIG. 6. In this state, the center portion Pbc of the roll paper P (Pb) in the width direction is at the reference position C.

Further, although the rear guide 21 moved toward the reference position C from the state shown in FIG. 6, since the rear guide 21 is in contact with the surface Pba of the roll paper P (Pb), the sensor 25 and the roll paper P (Pb) are kept close to each other at a predetermined distance. This predetermined distance is the same distance as the distance between the sensor 25 and the roll paper P (Pa). In this state, if the roll paper P (Pb) is used, the diameter of the roll paper P (Pb) decreases, and the diameter becomes smaller than a predetermined diameter, and if the reflected amount of the light emitted from the sensor 25 by the surface Pba becomes less than or equal to a predetermined amount, the sensor 25 detects that the roll paper P (Pb) is near-end. The near-end detection accuracy of the roll paper P (Pb) by the sensor 25 at this time is equivalent to the detection accuracy of the sensor 25 detecting the near end of the roll paper P (Pa) since the distance between the sensor 25 and the surface Pba of the roll paper P (Pb) is the same as the distance from the surface Paa of the roll paper P (Pa).

From here on, the mounting structure of the sensor harness 28 will be described. The sensor harness 28 is a cable that outputs the output signal of the sensor 25 to the control section (e.g., operatively couples the sensor 25 to the circuit board 17). If the sensor 25 detects that the roll paper P is at near-end, the sensor harness 28 outputs a signal indicating this detection to the control unit.

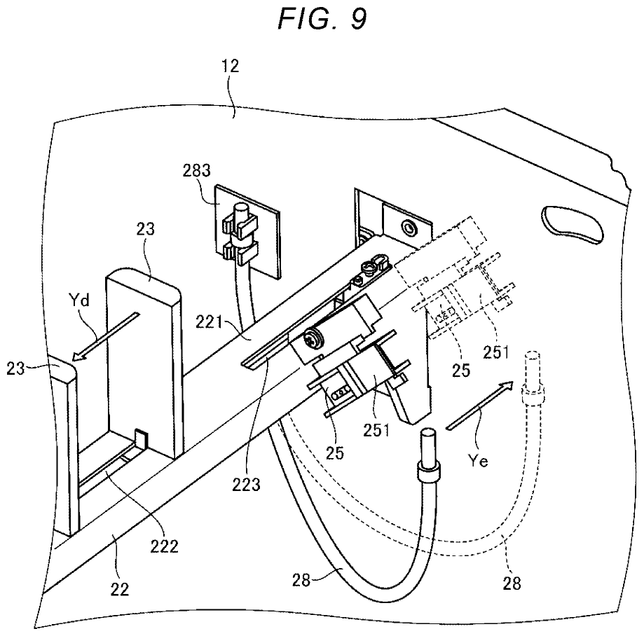

There is also a method of connecting the sensor harness 28 to the control unit through the inside of the support shaft 22. In this case, if the sensor 25 attached to the rear guide 21 moves in the width direction of the roll paper P together with the rear guide 21 in accordance with the width of the roll paper P, the sensor harness 28 connected to the sensor 25 is once extended toward the rotating shaft 241 (in the moving direction of the rear guide 21 (reference position C)) inside the support shaft 22, and then folded back abruptly (folded back with a small R shape (diameter) at the folded portion) inside the support shaft 22 and connected to the control unit. In this case, excessive stress is applied to the folded portion of the sensor harness 28, causing fatigue to accumulate in the folded portion. In such a situation, moving the rear guide 21 each time the roll paper P is loaded increases the risk that the folded portion of the sensor harness 28 will be damaged. For this reason, the embodiment proposes a mounting structure for the sensor harness 28 illustrated in FIGS. 8 and 9.

FIG. 8 is an explanatory diagram illustrating the mounting structure of the sensor harness 28 according to the embodiment. In FIG. 8, the rear guide 21 is described as semi-transparent in order to make the mounting structure of the sensor harness 28 easier to understand. As illustrated in FIG. 8, the sensor harness 28 has one side 281 attached to the base 27 and the other side 283 attached to the frame 12. The base 27 is attached to the rear guide 21. That is, one side 281 of the sensor harness 28 is attached near the sensor 25, and the other side 283 is attached to the frame 12 on the opposite side across the support shaft 22. The sensor harness 28 on one side 281 (attached to the base 27) is electrically connected to the sensor 25 by a cable 282, and the sensor harness 28 on the other side 283 (attached to the frame 12) is electrically connected to the control unit. If the rear guide 21 is moved in accordance with the width of the roll paper P, one side 281 moves in the width direction of the roll paper P together with the rear guide 21, but the other side 283 remains attached to the frame 12 and does not move.

In this case, the mounting position on one side 281 and the mounting position on the other side 283 of the sensor harness 28 are far apart, and the line connecting the mounting position on the one side 281 and the mounting position on the other side 283 is a direction that intersects the moving direction of the one side 281 (that is, the moving direction of the rear guide 21 and the sensor 25) (in the embodiment, it is a substantially perpendicular direction or a direction close to a right angle). Therefore, since there is no abruptly folded portion in the sensor harness 28 (the R shape (diameter) is large), excessive stress is not applied to the attached sensor harness 28 even if the rear guide 21 moves. Furthermore, since the sensor harnesses 28 attached to one side 281 and the other side 283 are provided with a margin (slack), excessive stress will not be applied to the attached sensor harnesses 28 even if the rear guide 21 moves. In addition, in FIG. 8, the sensor harness 28 is located deeper than the rear guide 21 (between the rear guide 21 and the frame 12).

Next, stress applied to the sensor harness 28 of the embodiment will be described. FIG. 9 is a diagram illustrating how stress is applied to the sensor harness 28 as the rear guide 21 moves. In FIG. 9, a solid line indicates the position and state of the sensor harness 28 before the rear guide 21 moves, and a dotted line indicates the position and state of the sensor harness 28 after the rear guide 21 moves. In FIG. 9, the rear guide 21 is omitted to make the movement of the sensor harness 28 easier to understand.

As illustrated in FIG. 9, if the rear guide 21 moves in the direction of the arrow Ye, one side 281 of the sensor harness 28 moves in the direction of the arrow Ye, but the other side 283 remains attached to the frame 12 and does not move. Therefore, since the stress applied to the sensor harness 28 is only the deformation caused by the movement of the one side 281, and the mounting position on the one side 281 and the mounting position on the other side 283 are far apart, the stress applied to the sensor harness 28 is small even if the rear guide 21 moves in the direction of the arrow Ye. Therefore, the risk of fatigue damage to the sensor harness 28 as the rear guide 21 moves is small.

As illustrated in FIG. 8, the sensor 25 is attached to the rear guide 21 at a position on a line connecting the support shaft 22 and the damper 26. At this position, whether the diameter of the roll paper P loaded to the support shaft 22 is large or small, the near-end detection of the sensor 25 is not affected by the paper pulled out from the roll paper P.

As described above, the printer 1 of the embodiment includes a support shaft 22 that pivotally supports a plurality of types of roll paper P having different widths, a rear guide 21 movable in the width direction of the roll paper P according to the type of roll paper P pivotally supported on the support shaft 22, which positions the roll paper P pivotally supported by the support shaft 22 in the center portion of the width direction of the roll paper P in a reference position C; and a sensor 25 that is attached to the rear guide 21 and detects a near end due to a change in the diameter of the roll paper P.

The printer 1 of the present embodiment is of a type that is mounted based on the center portion of the roll paper P in the width direction, and the detection accuracy of the sensor 25 can be maintained even if roll papers P with different widths are loaded.

The printer 1 of the embodiment further includes the frame 12 that partitions the circuit board 17 provided with a control circuit for controlling the printer 1, and a sensor harness 28 that bridges between the rear guide 21 and the frame 12.

In the printer 1 of the present embodiment, even if the rear guide 21 moves in the width direction of the roll paper P, the stress applied to the sensor harness 28 is small. Therefore, the risk of causing damage to the sensor harness 28 as the rear guide 21 moves is small.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiment, the printer 1 was described as an example of a paper conveying device. However, the paper conveying device is not limited to this, and may be any device other than the printer 1 as long as it is a device that conveys paper pulled out from roll paper P.

Further, in the embodiment, the platen is rotated to convey the paper. However, the present disclosure is not limited to this, and a mechanism other than the platen may be provided to convey paper.

Further, in the embodiment, the sensor harness 28 is attached so that the line connecting the one side 281 and the other side 283 intersects the moving direction of the rear guide 21. However, the present disclosure is not limited to this, and the sensor harness 28 may be attached in any manner as long as the sensor harness 28 does not have an abruptly folded portion.

Further, in the embodiment, the center portion of the roll paper P is aligned with the reference position C using the rack and pinion 24. However, the present disclosure is not limited to this, and the rack and pinion 24 is merely one example, and a mechanism other than the rack and pinion 24 may be used to align the center portion of the roll paper P with the reference position C.

What is claimed is:

1. A paper conveying device comprising:
a support shaft configured to pivotally support a roll of paper having a center measured in a width direction;
a guide movable in the width direction of the roll based on a size of the roll and configured to position the center of the roll in a reference position; and
a sensor coupled to the guide and configured to detect that the roll contains less than a threshold amount of paper based on a diameter of the roll.

2. The paper conveying device of claim 1, further comprising:
a rack and pinion assembly,
wherein the guide is coupled to the rack and pinion assembly and configured to position the center of the roll in the reference position by contacting a first side of the roll.

3. The paper conveying device of claim 2, wherein the rack and pinion assembly is positioned within the support shaft.

4. The paper conveying device of claim 3, wherein:
the rack and pinion assembly includes a rack gear coupled to the guide and a pinion gear engaging the rack gear;
the support shaft defines a slot extending in the width direction; and
the guide is coupled to the rack gear through the slot.

5. The paper conveying device of claim 4, wherein the support shaft includes a flat portion that defines the slot.

6. The paper conveying device of claim 2, wherein the guide is a first guide, and further comprising a second guide configured to position the center of the roll in the reference position by contacting a second side of the roll opposite the first side.

7. The paper conveying device of claim 6, wherein the rack and pinion assembly includes a first rack gear coupled to the first guide, a second rack gear coupled to the second guide, and a pinion gear engaging both the first rack gear and the second rack gear.

8. The paper conveying device of claim 6, wherein:
the second guide is rotatable relative to the support shaft between an erected position and a collapsed position; and
a distance between a distal end of the second guide and the support shaft is greater when the second guide is in the erected position than when the second guide is in the collapsed position. 9 The paper conveying device of claim 6, wherein:
the second guide is coupled to the rack and pinion assembly; and
in response to a movement of the first guide in a first direction, the rack and pinion assembly is configured to move the second guide in a second direction opposite the first direction.

10. The paper conveying device of claim 9, wherein in response to the movement of the first guide a distance in the first direction, the rack and pinion assembly is configured to move the second guide the same distance in the second direction.

11. The paper conveying device of claim 1, further comprising:
a partition that separates the guide from a circuit board provided with a control circuit configured to control the paper conveying device; and
a sensor harness having a first end portion coupled to the guide and a second end portion coupled to the partition.

12. The paper conveying device of claim 11, wherein the sensor harness operatively couples the sensor to the circuit board.

13. The paper conveying device of claim 1, further comprising:
a print head configured to print on the paper from the roll.

14. The paper conveying device of claim 1, wherein the sensor is an optical sensor configured to emit light toward the roll and receive reflected light.

15. The paper conveying device of claim 14, wherein the optical sensor is configured to emit infrared light.

16. The paper conveying device of claim 1, wherein:
the roll is a first roll having a first width measured in the width direction;
the support shaft is configured to pivotally support a second roll having a second width measured in the width direction, the second width being greater than the first width; and
the guide is configured to position a center of the second roll in the reference position.

17. A paper conveying device comprising:
a support shaft configured to pivotally support a roll of paper having a center measured in a width direction;
a first guide movable in the width direction of the roll;
a second guide movable in the width direction of the roll; and
a timing assembly coupled to the first guide and the second guide and configured to move the first guide in a first direction in response to a movement of the second guide in a second direction opposite the first direction.

18. The paper conveying device of claim 17, wherein the timing assembly is configured to move the first guide a distance in the first direction in response to the movement of the second guide the same distance in the second direction.

19. The paper conveying device of claim 17, wherein the timing assembly is positioned within the support shaft.

20. A paper conveying device comprising:
a partition;
a support shaft configured to support a roll of paper and extending away from the partition along a width direction of the roll;
a first guide movable along the support shaft in a first direction;
a second guide movable along the support shaft in a second direction opposite the first direction, the second guide being rotatable between an erected position and a collapsed position;
a first rack gear coupled to the first guide;
a second rack gear coupled to the second guide;
a pinion gear positioned within the support shaft and engaging the first rack gear and the second rack gear;
a sensor coupled to the first guide and configured to detect a diameter of the roll; and
a cable having a first portion fixed to the first guide and a second portion fixed to the partition.
